(19) United States
(12) Patent Application Publication
(10) Pub. No.: US 2003/0145705 A1
(43) Pub. Date: Aug. 7, 2003

(54) Fence

(76) Inventor: Blaine Miller, N. Hartville, OH (US)

Correspondence Address: Joseph A. Sebolt, SAND & SEBOLT, Aegis Tower, 4940 Munson St. NW, Suite 1100, Canton, OH, 44718, US

(21) Appl. No.: 10/066,846

(22) Filed: Feb. 4, 2002

(51) Int. Cl. B26D 7/01; B26D 7/02

(52) U.S. Cl. 83/468; 83/468.7

(57) ABSTRACT

An adjustable fence that provides a surface acting as a support and stop and includes an angled face with a measurement device thereon and further includes a plurality of grooves in which attachments such as clamps, miter gauges, stops, guides, jigs or fixtures are readily affixed.

### BACKGROUND OF THE INVENTION

1. Technical Field

The invention relates generally to support and stop devices used with power tools and, more particularly, to readily adjustable fence. Specifically, the invention relates to a readily adjustable fence that provides a surface acting as a support and stop and includes an angled face with a ruler thereon and further includes a plurality of grooves in which attachments such as clamps, miter gauges, stops, guides, jigs or fixtures are readily affixed.

2. Background Information

Woodworking tools such as table saws, band saws, radial arm saws, miter saws and boxes, drill presses, router table and a wide variety of other tools are typically used in a manner that requires an elongated surface against which the workpiece being acted on by the woodworking tool is held or supported against, and/or which attachments such as clamps, miter gauges, stops, guides, jigs or fixtures are readily affixed. A wide variety of these elongated surfaces, often referred to as fences or fence systems, have been developed and marketed.

One such fence is shown in U.S. Pat. No. 4,693,158 as a fence system with a stop mechanism. In this invention, the stop slides over the upright and angled section of fence and once in a desirable position clamps over the upright and angled section of fence. The fence includes also includes a body member that defines a work surface. A ruler is positioned on the angular surface such that the stop and other jigs often block a portion thereof.

U.S. Pat. No. 5,018,562 is a power tool fence system that includes a dovetail slot into which a stop block and a push fixture each having dovetail protrusions are in slidable engagement.

U.S. Pat. No. 5,038,486 is a miter gauge with a telescopic fence. The fence assembly includes an inner rail telescopically receiving an outer rail where each rail is provided with a retractable workpiece stop. Scales are provided thereon.

U.S. Pat. No. 5,337,641 is a woodworking machinery jig and fixture system that includes a track where a flip stop and an optional micro-adjuster mount to a T-shaped slot in the track.

Several patented fences including U.S. Pat. Nos. 5,553,644 and 5,768,966 employ many slots placed over one or two sides of the fence in hopes that a slot will be provided everywhere needed. No scales or rulers are provided.

These and the other fences patented, developed and marketed have to varying degrees satisfied some of the needs and desires of users. However, each tends to have some problems and difficulties including not being designed for optimal use; lacking scales; scales positioned such that jigs, stops or other attachments block or inhibit use of the scale; scales positioned so as to be difficult to use, clamping of jigs, stops or other attachments which is difficult to perform accurately; no means to attach jigs, stops or other attachments; grooves at ineffective positions; insufficient number of grooves; grooves at ineffective angles or locations; in-flexible fences for a variety of uses; lack of attachments; are difficult to use; have many pieces; require lengthy assembly for proper use; and many other reasons as are well known or readily recognized by one of skill in the art.

The need thus exists for an improved fence such as clamps, miter gauges, stops, guides, jigs or fixtures are readily affixed. The present invention addresses the problems of the prior art devices and also provides for improvements that are utilized in the construction of an improved fence.

### BRIEF SUMMARY OF THE INVENTION

In view of the foregoing, advantages are obtained by the improved fence of the present invention, the general nature of which may be stated as including a fence for use with a woodworking tool such as one of a table saw, band saw, radial arm saw, miter saw, drill press, and router for altering materials, where the woodworking tool includes a working surface on which the materlas are altered and the woodworking surface including at least one elongated slot. The fence including an elongated body having a top end including a top end slot, a front face including at least one front slot, and a back face opposed to the front face and including a back slot. The fence also including a planar face integrally extending outward, from approximately the intersection of top end and back face, in an angular manner in relation to the fence body. The fence further including a measurement device seated on the planar face.

### BRIEF DESCRIPTION OF THE SEVERAL VIEWS OF THE DRAWINGS

The preferred embodiment of the invention, illustrative of the best mode in which applicant has contemplated applying the principles of invention, is set forth in the following description and is shown in the drawings and is particularly and distinctly pointed out and set forth in the appended claims.

FIG. 1 is a front view of one type of woodworking tool, specifically a router table, on which the fence of the present invention is attached;

FIG. 2 is a top view of the woodworking tool of FIG. 1 with the fence of the present invention thereon;

FIG. 3 is a back view of the woodworking tool of FIG. 1 with the fence of the present invention thereon;

FIG. 4 is a partial side view of the woodworking tool of FIG. 1 with the fence of the present invention thereon;

FIG. 5 is a perspective fragmentary view of the fence of the present invention with the scale shown removed from its seat;

FIG. 6 is a perspective fragmentary view of the fence of the present invention with the scale shown seated on the fence;

FIG. 7 is a sectional view of the fence of the present invention on the woodworking tool taken along lines 7-7 in FIG. 2;

FIG. 8 is a sectional view of the fence of the present invention on the woodworking tool taken along lines 8-8 in FIG. 2;

FIG. 9 is a sectional view of the fence of the present invention on the woodworking tool taken along lines 9-9 in FIG. 2;

FIG. 10 is the same sectional view as FIG. 9 except that the fence is in a tilted position;

FIG. 11 is the same side view as FIG. 4 with a stop affixed into the fence;

FIG. 12 is the same front view as FIG. 1 except that the stop of FIG. 11 has been added;

FIG. 13 is a partial fragmentary top view similar to FIG. 2 except that the stop of FIG. 11 has been added; and

FIG. 14 is the same fragmentary top view as FIG. 13 except that the stop of FIG. 11 is being slid across the fence.

Similar numerals refer to similar parts throughout the specification

### DETAILED DESCRIPTION OF THE INVENTION

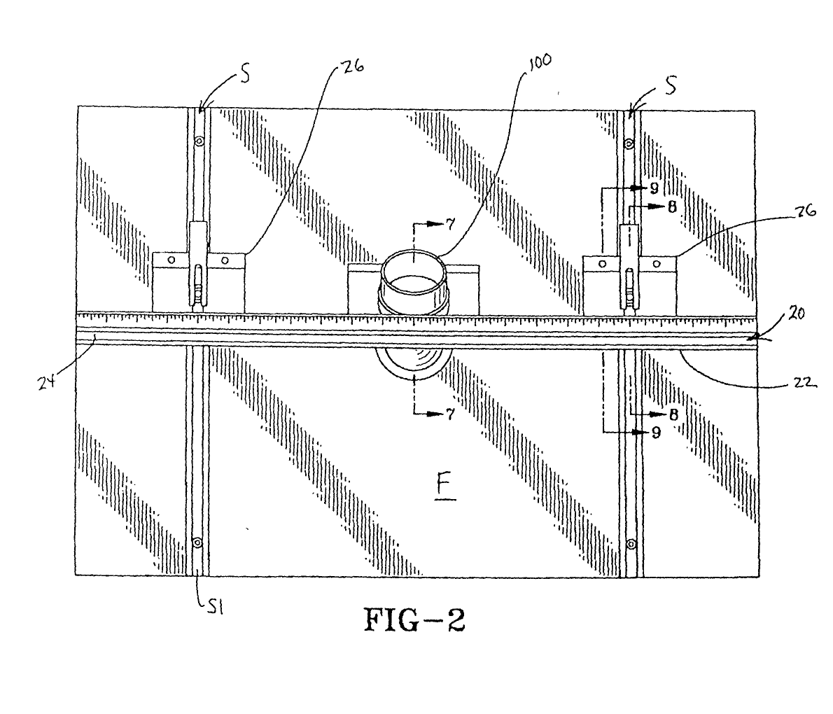

Referring to the drawings, wherein like numerals represent like parts throughout the several views, there is generally disclosed at W a woodworking tool or bench such as a table saws, band saws, radial arm saws, miter saws and boxes, drill presses, router table and a wide variety of other tools are typically used in a manner that requires a working face F on which an elongated surface against which the workpiece being acted on by the woodworking tool is held or supported against. In the embodiment shown this woodworking tool is a router table with a router R attached thereto having a woodworking bit B such as a router bit in this case (but in other embodiments this may be a drill bit, saw blade, cutting element, etc. as is well known in the art); however in the case of any woodworking tool the tool W has the working face F and various supports such as legs L. As best shown in FIG. 2, the working face F includes elongated slots S which may be machined wholly therein, or merely be a groove in which a slot is affixed. In either case each slot is typically of a dove tail or “T” design such that the portion of the slot nearest the working surface S1 is smaller in width than deeper sections S2 so as to be able to readily affix attachments such as the fence system 20 of this invention thereto using locking devices that are selectively securable within the slot S. It is contemplated that other attachment methods such as simple fasteners could be used as are readily recognizable by one of skill in the art.

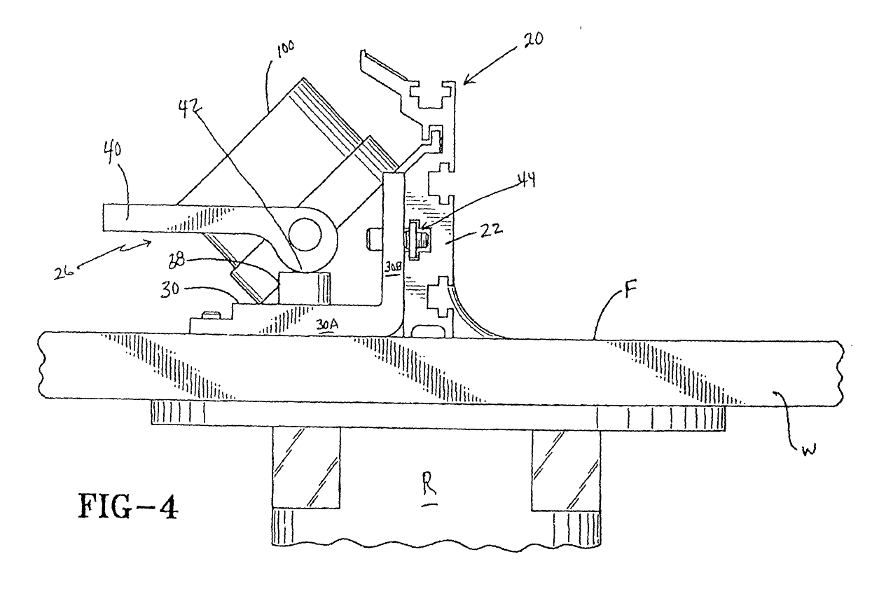

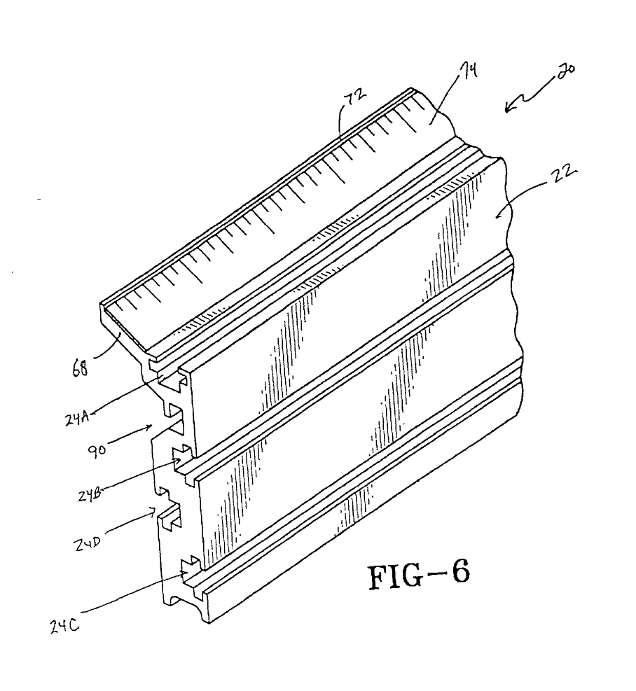

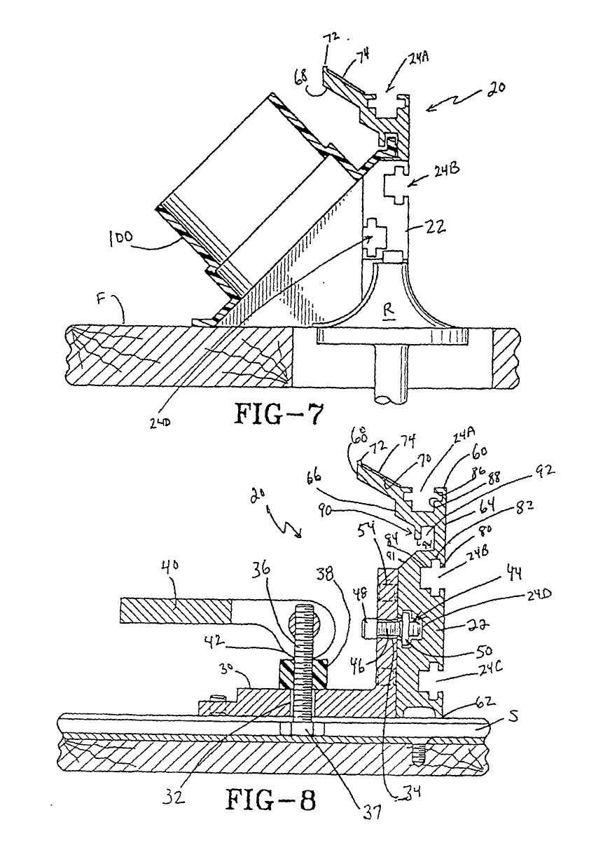

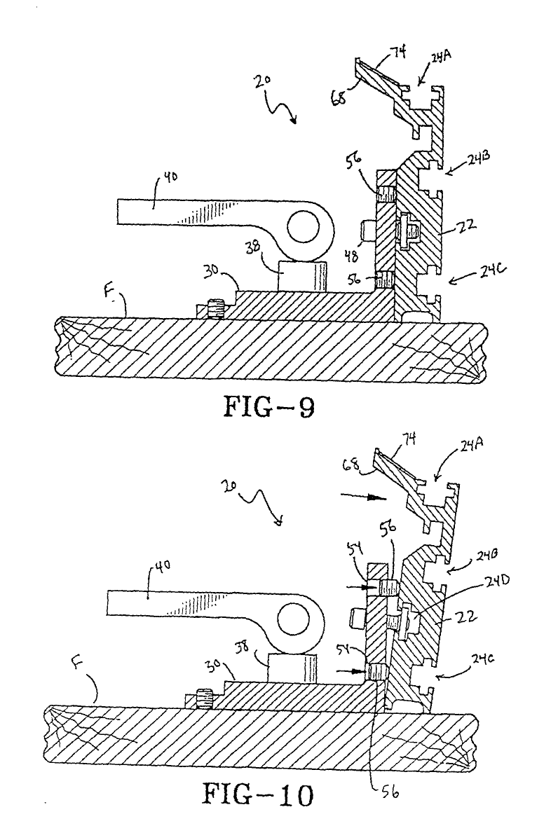

In accordance with the present invention, a fence or stop mechanism 20 as best shown in FIGS. 4-11 includes an elongated body 22 with a plurality of elongated attachment slots 24 therein. The fence mechanism 20 also includes at least one locking device 26 that in the embodiment shown includes an L-shaped plate 30 with a first face 30A and a second face 30B. The first face 30A has an anchor hole 32 therein while the second face 30B has an attachment hole 34 therein.

The locking device 26 further includes a translating rod 36 with an enlarged head 37 on one end thereof that is insertable through anchor hole 32 whereby the head is of a larger diameter than the hole. An optional spacer 38 and a handle 40 with a cam surface 42 are pivotably connected to the translating rod 34 opposite the head. The locking device 26 also includes a T-fastener 44 with a threaded shaft 46 terminating in a head 48 of a diameter larger than the shaft and further including a lock ring 50 threaded on the shaft 46 and of a diameter larger than the shaft 46. One or more adjustment holes 54 may be present in one or more of the faces of the L-shaped plate whereby a threaded insert 56 is threaded therein and may be extended from the face to forcibly and securably tilt the elongated body 22 as described below for creating an angled fence as shown in FIG. 10.

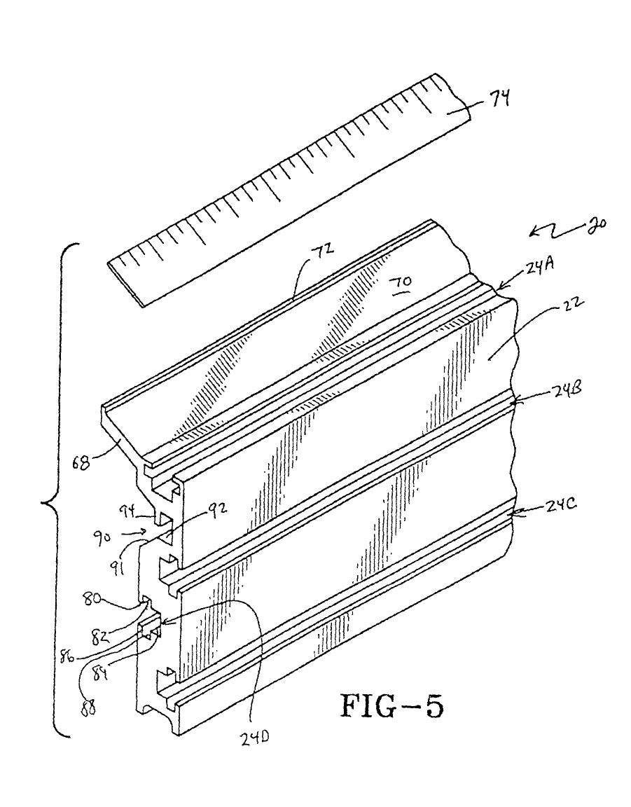

The elongated body 22 is of a generally rectangular cross section with a top end 60 and a bottom end 62, and a front face 64 and a back face 66, except that it includes a wing 68 at top end 60 which is of a more slender thickness and extends from the body in a transverse manner as best shown in FIGS. 5-6. In the embodiment shown, the wing 68 extends from an outer edge of top end 60 and defines a top surface 70 that is slightly recessed due to an outermost lip 72. A measurement device such as a ruler 74 is preferably seated and secured to the top surface 70. The wing 68 is thus angularly extended from the body 22 in such a manner to provide the best view of the measurement device in operation.

The elongated body 22 further includes the elongated attachment slots 24, and in the embodiment shown specifically a top end slot 24A in top end 60, a pair of front slots 24B and 24C in front face 64, and a back slot 24D in back face 66. All of these slots 24 (24A, 24B, 24C and 24D) are of the same configuration which may be of a T-shaped or + shaped cross section. In the embodiment shown the slots are of a plus (“+”) shape with a first portion 80 adjacent to and open to the given surface the slot is cut in, a second portion 82 that is adjacent to and of a larger cross section than the first portion, and an optional third portion 84 that is adjacent to and of a smaller cross section than the second portion. This design defines an outer shoulder 86 and an inner shoulder 88 in each slot.

The back face 66 also includes a tapered slot 90. Tapered slot 90 has a tapered surface adjacent to and open to the back face 66 that tapers or narrows to a well portion 92. The well portion 92 includes a locking tab 94 extending inward from one of the side walls of the well.

In the most preferred embodiment, the slots 24B and 24C are separated by a significant gap such that the bottom front slot 24C more proximate to the adjacent bottom end 62 while top front slot 24B is at least slightly closer to the top end 60 than the bottom end 62. In addition, the back slot 24D is positioned to be approximately mid-way between the slots 24B and 24C but on the opposite face. The tapered slot 90 is positioned between the top end 60 and the back slot 24D and preferably approximately mid-way between the top end 60 and the top front slot 24B but on the opposite face. The top end slot 24A is preferably centered in the top end 60.

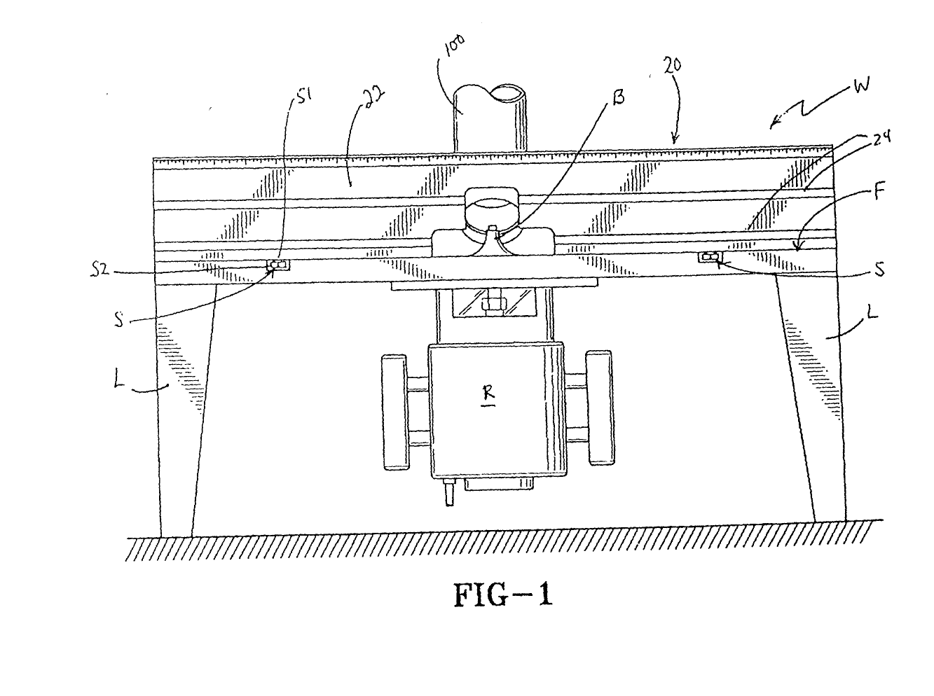

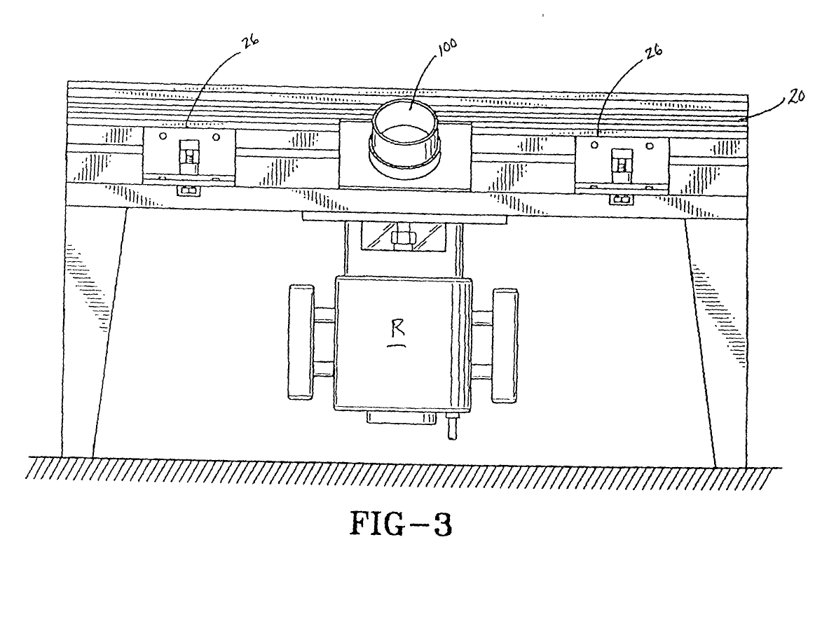

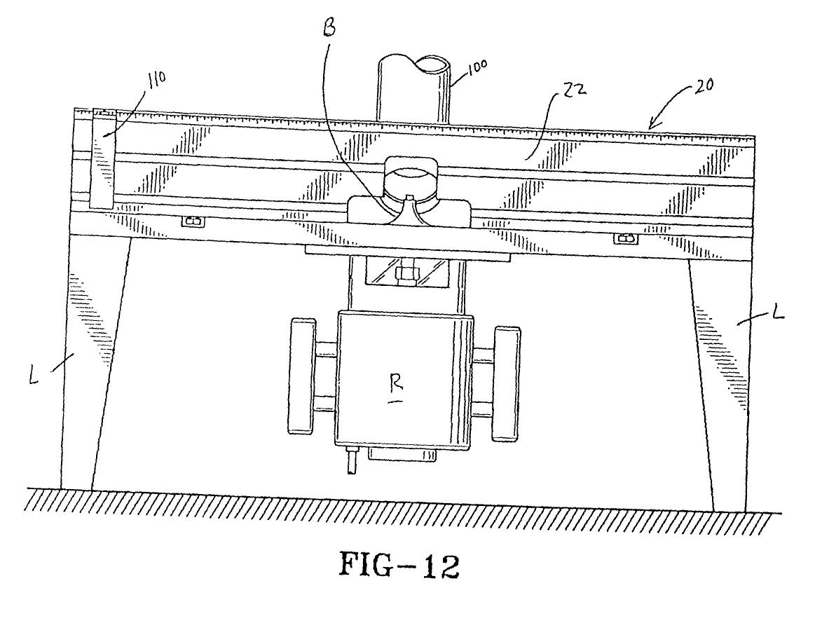

A variety of attachments may be affixed to the plurality of elongated attachment slots 24 and/or the tapered slot 90. These include a hose collar 100 as shown in FIGS. 1-3, 7, and 11-12 which affixes to a flexible hose that is in turn connected to a vacuum system for removing saw dust and the like. In this case, the hose collar 100 is slidably positioned within the slot 90 as is shown.

Other attachments A that may be slidably positioned in one of the slots include clamps, miter gauges, stops, guides, jigs, fixtures or other desirable devices.

In assembly and use, the T-fastener 44 associated with each locking device 26 is inserted onto attachment hole 34 in L-shaped plate 30 such that head 48 is tightly against the second face 30B on the side opposite the side resting against or near the fence 20. Each locking device 26 is attached to the fence 20; specifically, lock ring 50 is threaded partially onto the shaft 46, and then the locking device 26 is slid into back slot 24D. Once each locking device 26 is properly positioned against the fence 20, the threaded shaft is rotated so as to threadably pull the lock ring 50 into tight engagement with an outer shoulder 86 in the back slot 24D thereby securing the locking device 26 to the fence 20.

The fence may now be secured to the working face F of the woodworking tool W. The heads 37 of the locking device 26 are slid into the elongated slots S from one of the ends such that the fenced 20 is loosely restricted from being pulled transversely away from the working face F. Once the fence 20 is positioned as desired on the working face F, the handle 40 with its cam surface 42 is pivoted on optional spacer 38. In the preferred embodiment, when the handle 40 pivots from a substantially vertical position where the handle 40 is axially aligned with the rod 36 to a substantially horizontal position where the handle 40 is substantially perpendicular to the rod 36, the cam surface causes the translating rod 36 to be pulled toward the handle 40. The result of this pulling of the rod 36 is that head 37 is pulled into tight engagement with an outer shoulder in the elongated slot S thereby securing the fence 20 via the locking device 26 to the working face F.

Once the fence is secured, any of a variety of attachments may be affixed to the plurality of elongated attachment slots 24 and/or the tapered slot 90. As noted above, one of these attachment is the hose collar 100. If desirable, the hose collar 100 is slidably positioned within the slot 90 as is shown, and is secured using the same or a similar securing process and the same or similar T-fastener to that of T-fastener 44 above.

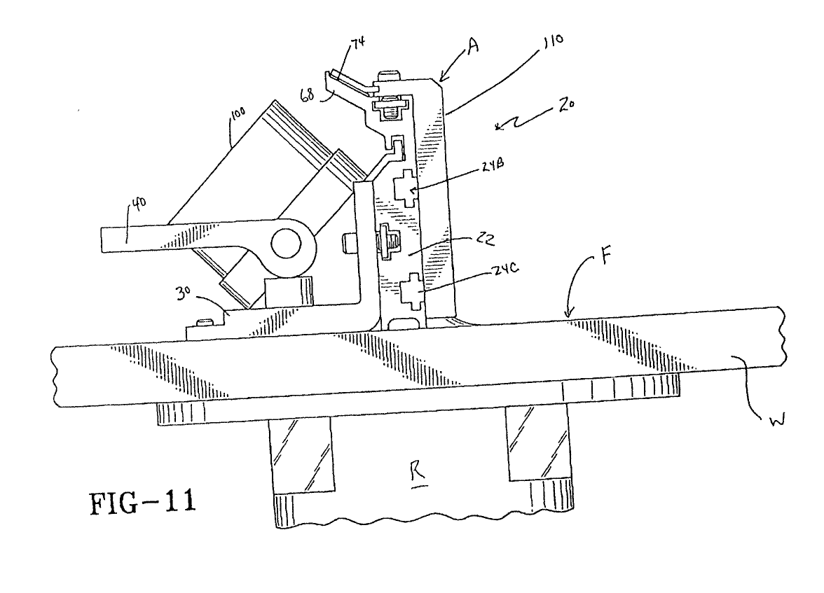

Other attachments A that may be slidably positioned in one of the slots include clamps, miter gauges, stops, guides, jigs, fixtures or other desirable devices. One such device is shown in FIGS. 11-13 as attachment 110 embodied here as a stop or guide. This attachment is similarly installed by sliding the attachment 110 into appropriately selected slot 24, in this case 24A, and once properly positioned, securing the attachment 110 using the same or a similar securing process and the same or similar T-fastener to that of T-fastener 44 above.

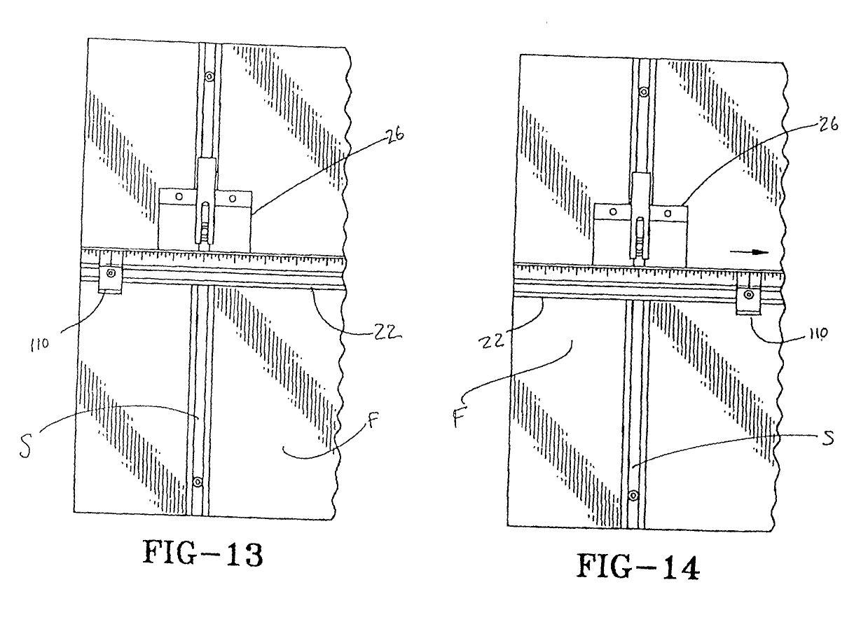

The guide 110 is of an inverted “L” shape with a fastener hole in the small top leg thereof. A T-fastener such as 44 described above is used therein to secure the guide 110 to the top slot 24A in the manner described above. To use the guide, it is slid into or out of the slot 24A (see FIG. 14) until properly positioned where the T-fastener 44 secures it in a desired and accurate position as is readily determined by the measurement device 74 (see FIG. 13).

By providing slots 24A, 24B, 24C and 24D, or other possible numbers or arrangements of slots, on front face 64, back face 66 and top end 60, the fence 20 maximizes the number of attachments and locking devices, provides the ability to position those not necessary for the woodworking process on top or behind the working area, provides for an easy vacuum connection, and provides a measurement device that is optimally positioned for viewing and accurate measuring while not in the way of or blocked by the attachments. The invention is also flexible enough to be used on almost any woodworking equipment, tool or bench such as a table saws, band saws, radial arm saws, miter saws and boxes, drill presses, router table and a wide variety of other tools, and is readily interchangeable between such tools.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described. Other modifications of the invention will be apparent to those skilled in the art in light of the foregoing description.

Having now described the features, discoveries, and principles of the invention, the manner in which it is constructed and used, the characteristics of the construction, and the advantageous new and useful results obtained; the new and useful structures, devices, elements, arrangements, parts, and combinations are set forth in the appended claims.

1. A fence for use with a woodworking tool such as one of a table saw, band saw, radial arm saw, miter saw, drill press, and router for altering materials, where the woodworking tool includes a working surface on which the materlas are altered and the woodworking surface including at least one elongated slot, the fence comprising:
an elongated body having a top end including a top end slot, a front face including at least one front slot, and a back face opposed to the front face and including a back slot;
a planar face integrally extending outward, from approximately the intersection of top end and back face, in an angular manner in relation to the fence body; and
a measurement device seated on the planar face.

2. The fence of claim 1 wherein the front face includes a top front slot and a bottom front slot, and wherein the back face includes back slot and a tapered slot.

3. The fence of claim 2 wherein the top front slot, the bottom front slot, the top end slot and the back slot are T-shaped grooves.

4. The fence of claim 3 wherein each T-shaped grooves includes a first portion adjacent to and open to the respective surface of the top end, front face and back face the groove is cut in, and a second portion that is adjacent to and of a larger cross section than the first portion.

5. The fence of claim 1 wherein the top front slot, the bottom front slot, the top end slot and the back slot are plus-shaped grooves.

6. The fence of claim 5 wherein the plus-shaped grooves include a first portion adjacent to and open to the respective surface of the top end, front face and back face the groove is cut in, a second portion that is adjacent to and of a larger cross section than the first portion, and a third portion adjacent to and of a smaller cross section than the second portion, and wherein the first and second portions define an outer shoulder, and the second and third portions define an inner shoulder in each slot.

7. The fence of claim 6 further comprising an attachment such as one of a clamp, miter gauge, stop, guide, jig, and fixture where the attachment includes a T-fastener comprising a threaded shaft terminating in a head of a diameter larger than the shaft and further including a lock ring threaded on the shaft and of a diameter larger than the shaft whereby rotation of the threaded shaft causes axial movement of the lock ring on the threaded shaft so as to allow the lock ring to be pulled tightly against an outer shoulder in the plus-shaped groove as the threaded shaft is rotated.

8. The fence of claim 7 further comprising a locking device for securing the fence to the woodworking tool, the locking device including a translating rod with an enlarged head on one end thereof that is insertable through an anchor hole in the locking device, and further including a handle whereby pivotal movement of the handle causes axial motion of the translating rod within the anchor hole such that the enlarged head when positioned within the elongated slots of the working face is moved from a unlocked to a locked position within the elongated slot, and the locking device further including a T-fastener comprising a threaded shaft terminating in a head of a diameter larger than the shaft and further including a lock ring threaded on the shaft and of a diameter larger than the shaft whereby rotation of the threaded shaft causes axial movement of the lock ring on the threaded shaft so as to allow the lock ring to be pulled tightly against an outer shoulder in the plus-shaped groove as the threaded shaft is rotated.

9. The fence of claim 8 wherein the tapered slot has a tapered surface adjacent to and open to the back face that narrows to a well portion that includes a locking tab extending inward into the well.

10. The fence of claim 2 wherein the tapered slot has a tapered surface adjacent to and open to the back face that narrows to a well portion that includes a locking tab extending inward into the well.

11. The fence of claim 10 wherein one of the locking device and the elongated body includes at least one threaded port with a threaded insert therein which may be extended therefrom to forcibly and securably tilt the locking device and elongated body in relation to one another.

12. The fence of claim 10 wherein a hose collar and vacuum hose are attached within the tapered slot.

13. The fence of claim 6 further comprising a stop of an inverted L-shaped design that includes a T-fastener comprising a threaded shaft terminating in a head of a diameter larger than the shaft and further including a lock ring threaded on the shaft and of a diameter larger than the shaft whereby rotation of the threaded shaft causes axial movement of the lock ring on the threaded shaft so as to allow the lock ring to be pulled tightly against an outer shoulder in the plus-shaped groove as the threaded shaft is rotated.

14. A woodworking tool for altering materials, comprising:
a working surface on which materials are altered, the surface including at least one elongated slot;
a fence including a top end and opposed bottom end, and a front face and opposed back face, the fence further including a plurality of attachment receiving grooves therein where at least one groove is in each of the top end, front face and back face, and the fence further including a measurement device extending outward from the top end; and
a locking device attachable to the fence via one of the plurality of attachment receiving grooves and attachable to the working surface via the at least one elongated slot.

15. The woodworking tool of claim 14 wherein the measurement device extends outward approximate the intersection of the top end and back face in an angular manner in relation to the fence.

16. The woodworking tool of claim 14 wherein the plurality of attachment receiving grooves include a plurality of T-shaped grooves.

17. The woodworking tool of claim 16 wherein the T-shaped grooves include a first portion adjacent to and open to the respective surface of the top end, front face and back face the groove is cut in, and a second portion that is adjacent to and of a larger cross section than the first portion.

18. The woodworking tool of claim 14 wherein the plurality of attachment receiving grooves include a plurality of plus-shaped grooves.

19. The woodworking tool of claim 18 wherein the plus-shaped grooves include a first portion adjacent to and open to the respective surface of the top end, front face and back face the groove is cut in, a second portion that is adjacent to and of a larger cross section than the first portion, and a third portion adjacent to and of a smaller cross section than the second portion, and wherein the first and second portions define an outer shoulder, and the second and third portions define an inner shoulder in each slot.

20. The wood working tool of claim 19 wherein the locking device further comprises a translating rod with an enlarged head on one end thereof that is insertable through an anchor hole in the locking device, and further including a handle whereby pivotal movement of the handle causes axial motion of the translating rod within the anchor hole such that the enlarged head when positioned within the elongated slots of the working face is moved from a unlocked to a locked position within the elongated slot.
